(19) United States
(12) Patent Application Publication
(10) Pub. No.: US 2017/0306897 A1
(43) Pub. Date: Oct. 26, 2017

(54) EXHAUST SYSTEM FOR VEHICLES AND CONTROL METHOD THEREOF

(71) Applicant: Hyundai Motor Company, Seoul (KR)

(72) Inventor: Ki Hoon NAM, Gunpo-si (KR)

(73) Assignee: Hyundai Motor Company, Seoul (KR)

(21) Appl. No.: 15/264,842

(22) Filed: Sep. 14, 2016

(30) Foreign Application Priority Data
Apr. 22, 2016 (KR) 10-2016-0049276

(51) Int. Cl. F02M 26/33; F02M 26/24; F02D 41/00; F02D 41/02

(52) U.S. Cl. CPC F02M 26/33; F02D 41/0235; F02M 26/24; F02D 41/005

(57) ABSTRACT

An exhaust system for vehicles and a control method for the system are disclosed. The exhaust system for vehicles includes: a first channel including a plurality of first unit flow paths formed by stacking a plurality of heat exchanger plates provided with heat exchanger fins; a second channel provided in parallel with the first channel and including a plurality of heat exchanger tubes respectively forming a plurality of second unit flow paths having a greater cross-sectional area than a cross-sectional area of the first unit flow paths; an opening and closing unit provided to selectively shield the first channel and the second channel; and a controller provided to control the opening and closing unit according to driving conditions of a vehicle so as to control flows of exhaust gas to the first channel and the second channel.

### CROSS-REFERENCE TO RELATED APPLICATION

This application claims the priority to and the benefit of Korean Patent Application No. 10-2016-0049276, filed on Apr. 22, 2016, which is incorporated herein by reference in its entirety.

### FIELD

The present disclosure relates to an exhaust system for vehicles and a control method thereof in order to effectively cool exhaust gas.

### BACKGROUND

The statements in this section merely provide background information related to the present disclosure and may not constitute prior art.

In driving of a vehicle, exhaust gas generated due to combustion of a fuel includes emission regulated substances which may be harmful to humans or contaminate the atmosphere according to driving conditions of the vehicle, etc. Emission regulated substances include carbon oxides, nitrogen oxides, etc.

In order to reduce the emission amount of such emission regulated substances, vehicles may be provided with various exhaust gas purification systems. An Exhaust Gas Recirculation (EGR) system, which recirculates a part of exhaust gas to an intake side to greatly reduce such emission regulated substances through a recombustion process in an engine, correspond to one of these exhaust gas purification systems.

When exhaust gas, the temperature of which is increased through the combustion process in an engine, is introduced into an intake side, the amount of intake air introduced into the combustion process in the engine is greatly reduced by high-temperature expansion and thus engine efficiency may be lowered. Therefore, an EGR cooler (cooling path) to cool an exhaust gas flow through EGR may be provided.

However, according to driving conditions of a vehicle, such as a regeneration mode of a DPF of an exhaust gas purification device or a cold driving state, the amount of foreign substances, such as incompletely combusted carbon oxides in exhaust gas, may be rapidly increased, as compared to a normal case.

In this situation, we have discovered that the foreign substances are attached to a cooling path of exhaust gas which has a small cross-sectional area so as to improve cooling efficiency of exhaust gas, and thus there is high likelihood of clogging the cooling path by the foreign substances.

The above description has been provided to aid in understanding of the background of the present disclosure and should not be interpreted as conventional technology known to those skilled in the art.

### SUMMARY

The present disclosure provides an exhaust system for vehicles which inhibits an exhaust gas cooling path from being clogged with foreign substances according to driving conditions of the vehicle and achieves effective exhaust gas cooling efficiency, and a control method thereof.

The present disclosure provides an exhaust system for vehicles, including: a first channel including a plurality of first unit flow paths formed by stacking a plurality of heat exchanger plates provided with heat exchanger fins, a second channel provided in parallel with the first channel and including a plurality of heat exchanger tubes respectively forming a plurality of second unit flow paths having a greater cross-sectional area than a cross-sectional area of the first unit flow paths, an opening and closing unit provided to selectively shield the first channel and the second channel, and a controller provided to control the opening and closing unit according to driving conditions of a vehicle so as to control flows of exhaust gas to the first channel and the second channel.

The first channel and the second channel may be provided on an exhaust path to recirculate exhaust gas to an intake side so as to cool exhaust gas.

The opening and closing unit may be provided at a branch point of the exhaust path between inlets of the first channel and the second channel and selectively shield any one of the first channel and the second channel.

The opening and closing unit may be provided at the branch point so as to be rotatable and be rotated to selectively shield any one of the first channel and the second channel.

If the driving condition of the vehicle corresponds to a regeneration mode of an exhaust gas purification device, the controller may control the opening and closing unit to interrupt the flow of exhaust gas to the first channel and to permit the flow of exhaust gas to the second channel so as to inhibit or prevent incomplete combustion products in exhaust gas from being deposited in the first channel.

If the driving condition of the vehicle corresponds to a cold driving state, the controller may control the opening and closing unit to interrupt the flow of exhaust gas to the first channel and to permit the flow of exhaust gas to the second channel so as to inhibit or prevent incomplete combustion products in exhaust gas from being deposited in the first channel.

If the driving condition of the vehicle corresponds to a rapid acceleration state, the controller may control the opening and closing unit to interrupt the flow of exhaust gas to the first channel and to permit the flow of exhaust gas to the second channel so as to reduce flow resistance of exhaust gas.

If the driving condition of the vehicle does not correspond to the regeneration mode of the exhaust gas purification device, the cold driving mode and the rapid acceleration state, the controller may control the opening and closing unit to permit the flow of exhaust gas to the first channel and to interrupt the flow of exhaust gas to the second channel.

In another form, the present disclosure provides a control method of an exhaust system for vehicles. The method includes: judging, by a controller, whether or not the driving condition of a vehicle corresponds to a regeneration mode of an exhaust gas purification device or a cold driving state; and controlling, by the controller, an opening and closing unit provided between inlets of a first channel and a second channel to interrupt a flow of exhaust gas to the first channel including a plurality of first unit flow paths and to permit a flow of exhaust gas to the second channel including a plurality of second unit flow paths having a greater cross-sectional area than the cross-sectional area of the first unit flow paths so as to inhibit or prevent incomplete combustion products in exhaust gas from being deposited in the first channel, upon judging that the driving condition of the vehicle corresponds to the regeneration mode of the exhaust gas purification device or the cold driving state in judgment of the driving condition.

The control method may further include judging, by the controller, whether or not the driving condition of the vehicle corresponds to a rapid acceleration state, upon judging that the driving condition of the vehicle does not correspond to the regeneration mode of the exhaust gas purification device or the cold driving state in judgment of the driving condition.

Upon judging that the driving condition of the vehicle corresponds to the rapid acceleration state, the controller may control the opening and closing unit to interrupt the flow of exhaust gas to the first channel and to permit the flow of exhaust gas to the second channel so as to reduce flow resistance of exhaust gas in operation of the second channel.

The control method may further include controlling, by the controller, the opening and closing unit to permit the flow of exhaust gas to the first channel and to interrupt the flow of exhaust gas to the second channel, upon judging that the driving condition of the vehicle does not correspond to the rapid acceleration state.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a view illustrating a position of an EGR cooler in an exhaust system for vehicles in one form of the present disclosure;

FIG. 2 is a view illustrating an exhaust gas cooling path including a first channel in the exhaust system for vehicles according to the present disclosure;

FIG. 3 is a view illustrating an exhaust gas cooling path including a second channel in the exhaust system for vehicles according to the present disclosure;

FIG. 4 is a view illustrating an exhaust gas cooling path including a first channel and a second channel in the exhaust system for vehicles in one form of the present disclosure;

FIG. 5 is a view schematically illustrating a flow of exhaust gas by operating the first channel in the exhaust system for vehicles in accordance with the present disclosure;

FIG. 6 is a view schematically illustrating a flow of exhaust gas by operating the second channel in the exhaust system for vehicles in accordance with the present disclosure; and

FIG. 7 is a flowchart illustrating a control method of an exhaust system for vehicles in one form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

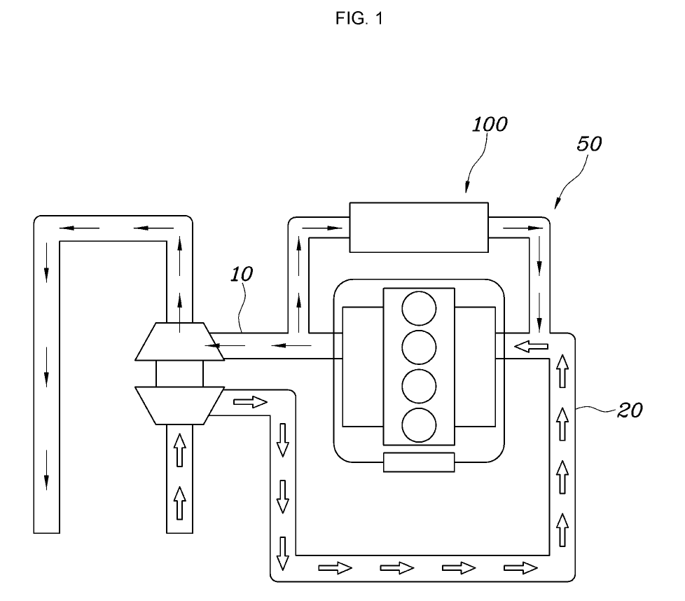

As shown in FIGS. 1 to 6, an exhaust system for vehicles in accordance with the present disclosure includes: a first channel 150 including a plurality of first unit flow paths 155, and a second channel 200 provided in parallel with the first channel 150 and including a plurality of second unit flow paths 205 having a greater cross-sectional area than the cross-sectional area of the first unit flow paths 155, an opening and closing unit 220 provided to selectively close the first channel 150 and the second channel 200, and a controller 250 configured to control the opening and closing unit 220 based on driving conditions of a vehicle so as to control an exhaust gas flow to the first channel 150 and the second channel 200.

In more detail, the first channel 150 is formed by the first unit flow paths 155, and the second channel 200 is provided in parallel with the first channel 150 and formed by the second unit flow paths 205 having a greater cross-sectional area than a cross-sectional area of the first unit flow paths 155.

In one form, the first channel 150 and the second channel 200 may be located on an exhaust path 10 along which exhaust gas flows so as to form a part of the exhaust path 10. Particularly, the first channel 150 and the second channel 200 of the present disclosure may be provided on an EGR path 50 along which a part of exhaust gas is recirculated to an intake side 20. FIG. 1 illustrates that the first channel 150 and the second channel 200 are provided on the EGR path 50 according to one form of the present disclosure.

Further, the first channel 150 and the second channel 200 of the present disclosure may correspond to an exhaust gas cooling path to cool exhaust gas and, more particularly, to an EGR cooler 100 to cool exhaust gas on the EGR path 50.

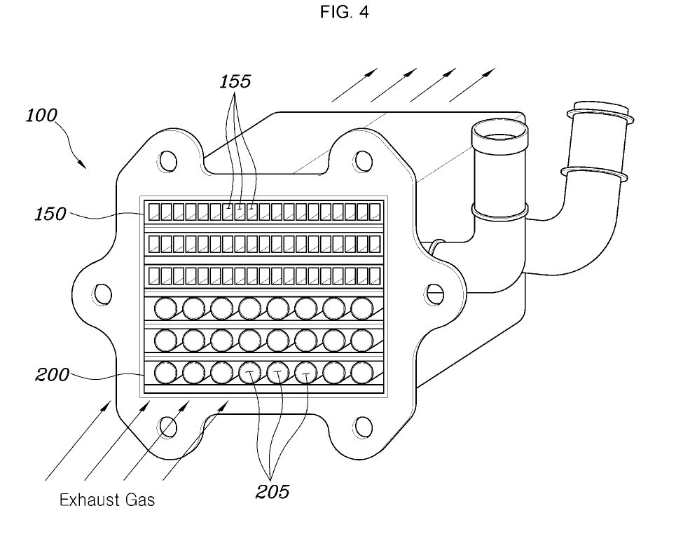

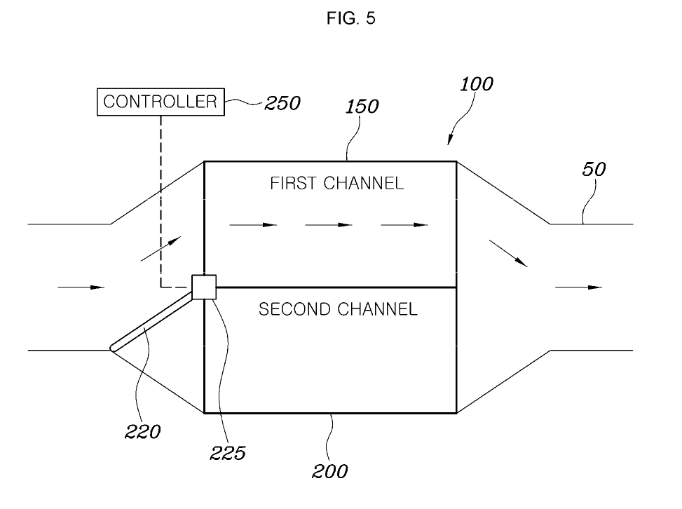

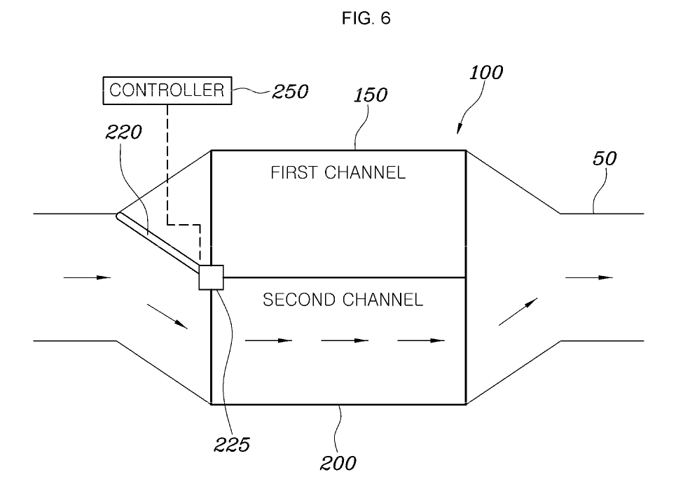

The first channel 150 and the second channel 200 are provided in parallel such that exhaust gas flowing along one channel does not flow along the other channel. That is, the first channel 150 and the second channel 200 are provided to have a structure in which the same exhaust gas does not flow along both the first channel 150 and the second channel 200. FIG. 4 illustrates the exhaust path 10 in which the first channel 150 and the second channel 200 are provided in parallel, and FIGS. 5 and 6 illustrates that the first channel 150 and the second channel 200 are provided in parallel on the exhaust path 10.

In a vehicle, the amount of foreign substances, such as incompletely combusted carbon oxides, in exhaust gas may be rapidly increased according to driving conditions of the vehicle, as compared to a normal state. In this situation, there is a high likelihood that the rapidly increased foreign substances in exhaust gas are attached to the exhaust path 10 and thus cause clogging of the exhaust path 10.

Therefore, the second unit flow paths 205 forming the second channel 200 have a greater cross-sectional area than a cross-sectional area of the first unit flow paths 155 forming the first channel 150, thus inhibiting or preventing the second channel 200 from being clogged due to adhesion of foreign substances even in a situation in which the amount of foreign substances in exhaust gas is increased under specific driving conditions.

That is, the first channel 150 is operated to flow exhaust gas under a general driving condition, and the second channel 200 is operated to flow exhaust gas under specific driving conditions in which the amount of foreign substances in exhaust gas is increased, thereby inhibiting or preventing clogging of the exhaust path 10 due to adhesion of foreign substances in exhaust gas.

The above-described driving conditions in which the amount of foreign substances in exhaust gas may be rapidly increased may be determined by experimental statistics or theoretical estimates, and representatively be a regeneration mode of a DPF, a cold driving state and a rapid acceleration state of a vehicle.

The cross-sectional area of the second unit flow paths 205 of the second channel 200 to inhibit or prevent clogging of the exhaust path 10 due to adhesion of foreign substances in spite of increase in the amount of foreign substances in exhaust gas may be variously determined experimentally or theoretically.

For example, a cross-sectional area to inhibit or prevent clogging of the exhaust path 10 due to adhesion of foreign substances may be determined by experimental statistics as a result of operating the exhaust path 10 for a designated time under a specific operating condition in which the amount of foreign substances in exhaust gas is increased, or several exhaust paths 10 having different cross-sectional areas may be tested, change of adhesion of foreign substances according to increase in the cross-sectional area may be analyzed theoretically and thereby a cross-sectional size to achieve a desirable inhibiting effect of clogging of the exhaust path 10 may be theoretically calculated.

The cross-sectional area of the first unit flow paths 155 of the first channel 150 is sufficient to be determined to have a level to inhibit or prevent clogging of the first unit flow paths 155 with foreign substances under the general driving condition (except for specific driving conditions judged as a case in that the amount of foreign substances in exhaust gas is rapidly increased), and such determination does not significantly differ from a determination method of the second unit flow paths 205.

Further, the first channel 150 and the second channel 200 may form an exhaust gas cooling path, and unlimited increase in the cross-sectional areas of the first channel 150 and the second channel 200 to inhibit or prevent clogging of the first channel 150 and the second channel 200 with foreign substances is not desirable in consideration of layout and cooling efficiency.

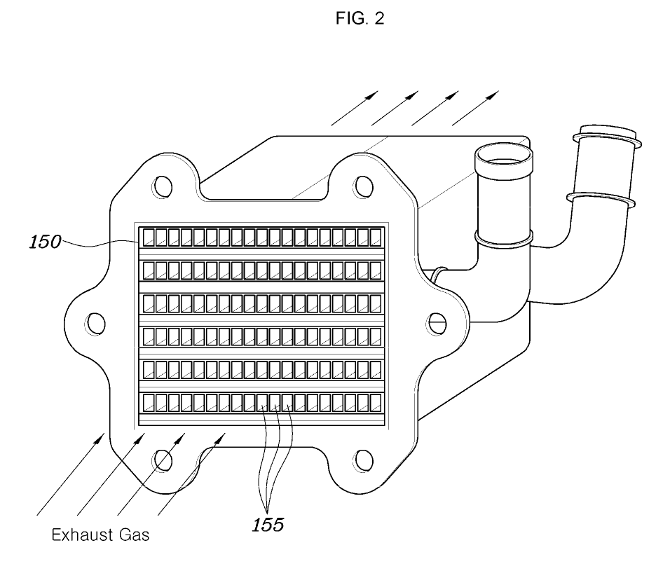

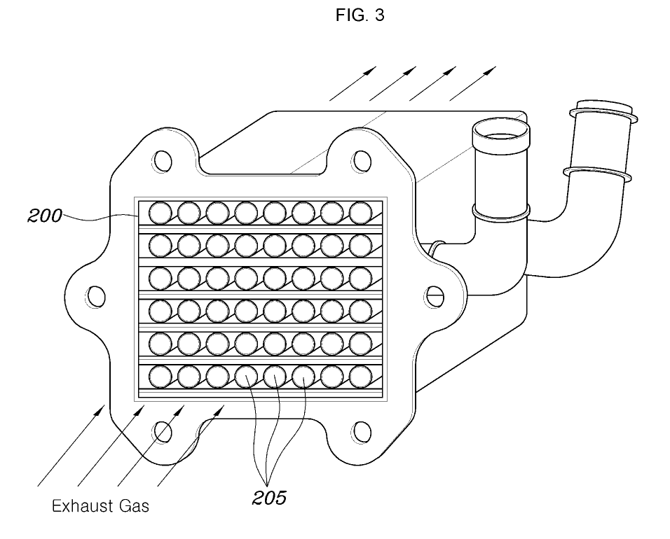

Therefore, the first and second unit flow paths 155 and 205 of the first channel 150 and the second channel 200 aim to have small cross-sectional areas but the cross-sectional areas of the first and second unit flow paths 155 and 205 may be determined in consideration of clogging with foreign substances. Here, the cross-sectional areas of the first and second unit flow paths 155 and 205 may be determined as a result of experimental statistics or theoretical calculation, as described above, or be variously determined according to kinds of engines or fuel consumption rates. FIG. 2 illustrates the first channel 150, and FIG. 3 illustrates the second channel 200. A difference in cross-sectional areas between the first and second unit flow paths 155 and 205 of the first channel 150 and the second channel 200 may be schematically understood through FIG. 4.

As shown in FIGS. 2 to 4, the first unit flow paths 155 of the first channel 150 are formed by stacking a plurality of heat exchanger plates provided with heat exchanger fins, and the second unit flow paths 205 of the second channel 200 are formed by a plurality of heat exchanger tubes.

In more detail, the first channel 150 includes the first unit flow paths 155 having a comparatively small cross-sectional area and densely disposed, as described above, and may thus be formed by stacking a plurality of heat exchanger plates provided with heat exchanger fins.

The respective heat exchanger fins may be provided in various types, i.e., be provided so as to contact the heat exchanger plate provided with the corresponding heat exchanger fins and other stacked heat exchanger plates, or protrude so as not to contact other stacked heat exchanger plates and thus to communicate the respective first unit flow paths 105 with each other.

Further, the heat exchanger fins may be molded integrally with the heat exchanger plate and the stack structure of the respective heat exchanger plates may be molded integrally. The heat exchanger fins and the heat exchanger plates may be formed of various materials which may easily exchange heat.

FIGS. 2 and 4 illustrate the first channel 150 in which a space between the respective heat exchanger plates is divided by the heat exchanger fins so as to form a plurality of first unit flow paths 155. Thereby, the first channel 150 greatly increases a contact area with exhaust gas and a heat exchange amount with exhaust gas, as compared to the second channel 200, thus having excellent exhaust gas cooling performance, as compared to the second channel 200.

In one form, the second channel 200 includes a plurality of second unit flow paths 205, as described above, and the second unit flow paths 205 need to have a comparatively large cross-sectional area and inhibit clogging with foreign substances and are thus formed by a plurality of heat exchanger tubes.

If the heat exchanger tubes have a polygonal or oval cross-sectional shape elongated to one side, parts of the second unit flow paths 205 having a small width may be clogged with foreign substances. Therefore, the heat exchanger tubes may have a regular polygonal or circular cross-sectional shape.

FIGS. 3 and 4 illustrate the second channel 200 in accordance with one form of the present disclosure in which heat exchanger tubes are provided so as to form the circular cross-sections of the second unit flow paths 205. The cross-sectional areas and the shapes of the first channel 150 and the second channel 200 may be compared with each other, through FIG. 4.

If the second channel 200 is formed by heat exchanger tubes having a circular cross-section, the second unit flow paths 205 have a greater cross-sectional area than the first unit flow paths 155 of the first channel 150 and thus clogging of the second unit flow paths 205 due to adhesion of foreign substances may be inhibited or prevented, and the second unit flow paths 205 have a uniform width in the radial direction of the cross-section thereof and thus there is no part in which clogging easily occurs and exhaust gas may easily flow.

That is, in one form of the present disclosure, the first channel 150 includes the first unit flow paths 155 having a small cross-sectional area and densely disposed by stacking heat exchanger plates provided with a plurality of densely disposed heat exchanger fins and may thus improve cooling performance of exhaust gas, and the second channel 200 includes a plurality of heat exchanger tubes having a circular cross-section and may thus greatly improve clogging with foreign substances in exhaust gas and reduce differential pressure between an inlet and an outlet.

The opening and closing unit 220 is provided to selectively shield the first channel 150 and the second channel 200. In more detail, the opening and closing unit 220 serves to selectively shield the first channel 150 and the second channel 200 so as to control an exhaust gas flow to the first and second channels 150 and 200.

A drive unit 225 to provide driving force to operate the opening and closing unit 220 may be separately provided, and the drive unit 225 may be one of various kinds of drive units, such as a pneumatic drive unit or a mechanical drive unit.

The opening and closing unit 220 may be one of various kinds of opening and closing units, as needed, i.e., a plate-type opening and closing unit which executes linear motion or a plate or vane-type opening and closing unit which executes rotational motion.

Further, the opening and closing unit 220 may be provided to selectively shield inlets or outlets of the first and second channels 150 and 200, or provided to selectively shield an upstream part or a downstream part communicating with the first and second channels 150 and 200.

FIGS. 5 and 6 illustrate the rotatable opening and closing unit 220 which selectively shields the inlets of the first and second channels 150 and 200. Exhaust gas may flow selectively along at least one of the first channel 150 and the second channel 20 by operation of the opening and closing unit 220.

The controller 250 is provided to control the opening and closing unit 220 according to driving conditions of the vehicle so as to control an exhaust gas flow along the first channel 150 and the second channel 200. FIGS. 5 and 6 schematically illustrate connection relations between the controller 250 and the opening and closing unit 220.

The controller 250 controls the opening and closing unit 220 according to driving conditions of the vehicle to control an exhaust flow to the first channel 150 and the second channel 200, and thereby exhaust gas may flow toward the first channel 150 or the second channel 200 depending on the driving conditions of the vehicle.

If the second channel 200 is operated, exhaust gas flows to the second unit flow paths 205 having a greater cross-sectional area than a cross-sectional area of the first unit flow paths 155. Here, the controller 250 operates the second channel 200 under specific conditions in which the amount of foreign substances in exhaust gas is rapidly increased and may thus inhibit clogging of the exhaust path 10 due to adhesion of foreign substances.

Further, the controller 250 may reduce exhaust gas pumping loss using the fact that differential pressure between the inlet and the outlet of the second channel 200 is smaller than the first channel 150 according to driving conditions of the vehicle. Particularly, if the first and second channels 150 and 200 are provided on the EGR path 50, supply of exhaust gas for rapid acceleration may be improved.

Since the first unit flow paths 155 of the first channel 150 have a small cross-sectional area and are densely disposed, as compared to the second unit flow paths 205, particularly if the first channel 150 is used as a cooling path of exhaust gas, a contact area between exhaust gas and the channel is increased and cooling efficiency of exhaust gas is improved, thus causing improvement effects of EGR efficiency in an EGR system.

That is, the controller 250 detects a driving condition of the vehicle by judging the operating state (i.e., RPM, fuel consumption rate, etc.) of the engine, a driving temperature (in cold driving, etc.) and the regeneration mode of the exhaust gas purification device (a DPF, etc.), and permits exhaust gas to flow through one of the first and second channels 150 and 200, which is suitable for the corresponding condition, and thus not only may effectively inhibit or prevent clogging of the exhaust path 10 due to increase in the amount of foreign substances in exhaust gas but also may improve cooling efficiency of exhaust gas and properly adjust an exhaust gas pumping load.

Further, as shown in FIG. 1, the first channel 150 and the second channel 200 are provided on the exhaust path 10 to recirculate exhaust gas to the intake side 20 so as to cool exhaust gas in the exhaust system for vehicles in accordance with the form of the present disclosure.

In more detail, in order to reduce emission regulated substances, the first channel 150 and the second channel 200 are provided on the EGR path 50 to recirculate exhaust gas of the vehicle to the intake side 20 to cool exhaust gas. FIG. 1 illustrates the first channel 150 and the second channel 200 as being provided on the EGR path 50 to cool exhaust gas.

As described above, exhaust gas flowing to the intake side 20 via the EGR path 50 needs to be cooled so as to improve engine efficiency. In one form, the first channel 150 and the second channel 200 are used as an exhaust gas cooling path on the EGR path 50.

The first channel 150 and the second channel 200 may be provided as various cooling types, such as an air-cooling type and a water-cooling type. In the case of the air-cooling type, outdoor air may be directly used or a separate fan may be provided and, in the case of the water-cooling type, a coolant of the engine may be used or a separate coolant line may be formed.

Further, the first unit flow paths 155 of the first channel 150 have a small cross-sectional area and are densely disposed, as described above, and may thus have excellent cooling performance of exhaust gas, as compared to the second channel 200. On the other hand, the second unit flow paths 205 of the second channel 200 have a large cross-sectional area, as compared to the first unit flow paths 155, and may thus have low cooling performance of exhaust gas as compared to the first channel 150 but inhibit or prevent clogging due to adhesion of foreign substances and be suitably operated under specific driving conditions in which the amount of foreign substances in exhaust gas is rapidly increased.

For example, under specific driving conditions, such as the regeneration mode of the exhaust gas purification device or the cold driving state, the amount of foreign substances in exhaust gas is increased and thereby the cooling path (the EGR cooler) 100 in the EGR system may be easily clogged with foreign substances. Here, clogging of the EGR path 50 may be inhibited or prevented by cooling exhaust gas through the second channel 200.

On the other hand, in a general driving condition except for the above-described specific driving conditions in which the amount of foreign substances in exhaust gas is increased, exhaust gas is cooled through the first channel 150 and thus cooling efficiency of exhaust gas may be improved.

In the rapid acceleration state of the vehicle, the amount of intake air introduced into the engine should be temporarily increased and, if the first channel 150 in which the unit flow paths having a small cross-sectional area are densely disposed is used as an exhaust gas cooling path, differential pressure between the inlet and the outlet of the first channel 150 is comparatively large and thus it may be difficult for a recirculation amount of exhaust gas to satisfy an increasing amount of intake air desired by the engine.

Even in this case, if the second channel 200 is operated to cool exhaust gas, differential pressure of the second channel 200 is smaller than differential pressure of the first channel 150 and thus a recirculation amount of exhaust gas may easily satisfy an increasing amount of intake air desired by the engine according to rapid acceleration of the vehicle.

Accordingly, the EGR cooler 100 of the EGR path 50 includes the first channel 150 and the second channel 200 and the controller 250 determines a situation in which cooling efficiency should be raised and a situation in which clogging with foreign substances should be inhibited or prevented and operates channels suitable for respective driving conditions, thus facilitating effective operation of the EGR system.

Further, as shown in FIGS. 5 and 6, in the exhaust system for vehicles, the opening and closing unit 220 is provided at a branch point of the cooling path where the inlet of the first channel 150 and the inlet of the second channel 200 are located and thus selectively shields any one of the first channel 150 and the second channel 200.

The first channel 150 and the second channel 200 are provided in parallel on the exhaust path 10 and the first and second channels 150 and 200 are branched from the upstream part of the exhaust path 10. FIGS. 5 and 6 illustrate that the first channel 150 and the second channel 200 are provided on the same exhaust path 10 such that the first channel 150 and the second channel 200 are branched from the upstream part of the exhaust path 10 and then joined at the downstream part of the exhaust path 10.

The opening and closing unit 220 is located between the inlets of the first channel 150 and the second channel 200. If the opening and closing unit 220 is located at the middle points or the outlets of the first and second channels 150 and 200, exhaust gas is introduced into a section from the shielded channel to the opening and closing unit 220.

For example, if the opening and closing unit 220 is provided at the outlets of the first and second channels 150 and 200, even though the amount of foreign substances in exhaust gas is increased and a flow of exhaust gas to the first channel 150 is interrupted by the opening and closing unit 220 so as to inhibit or prevent clogging of the first channel 150, exhaust gas having a large amount of foreign substances may be introduced into the first channel 150 and thus the first channel 150 may be clogged due to adhesion of the foreign substances.

Therefore, in one form the opening and closing unit 220 is provided at the branch point of the exhaust path 10, where the inlets of the first and second channels 150 and 200 are located, and when one channel is shielded, introduction of exhaust gas into the corresponding channel is inhibit or prevented. FIGS. 5 and 6 illustrate the opening and closing unit 220 as being provided between the inlets of the first and second channels 150 and 200.

Further, the opening and closing unit 220 is provided to selectively shield one of the first channel 150 and the second channel 200. Therefore, when the first channel 150 is shielded, the second channel 200 is opened so that exhaust gas flows through the second channel 200 and, when the second channel 200 is shielded, the first channel 150 is opened so that exhaust gas flows through the first channel 150.

That is, the single opening and closing unit 220 may control an exhaust gas flow towards both the first channel 150 and the second channel 200 and, when any one channel is shielded, the other channel is opened and thus complete interruption of the exhaust gas flow is inhibited or prevented.

Accordingly, the controller 250 determines a proper channel based on driving conditions of the vehicle and the single opening and closing unit 220 controls an exhaust gas flow to the first and second channels 150 and 200 so that exhaust gas may flow through the channel selected by the controller 250.

As shown in FIGS. 5 and 6, in the exhaust system for vehicles, the opening and closing unit 220 is provided at the branch point so as to be rotatable and is rotated to selectively shield any one of the first channel 150 and the second channel 200.

As described above, the single opening and closing unit 220 is provided such that, if the opening and closing unit 220 permits exhaust gas to flow to one of the first and second channels 150 and 200, an exhaust gas flow to the other channel is interrupted. For this purpose, the opening and closing unit 220 is provided at a point between the first channel 150 and the second channel 200 such that one end of the opening and closing unit 220 is rotatable, thus controlling the flow to both channels 150 and 200.

The opening and closing unit 220 may include the drive unit 225 to provide driving force for rotation and a plate unit to shield the respective channels 150 and 200, and one part of the opening and closing unit 220 may be hinged to a point between the first channel 150 and the second channel 200 so that the opening and closing unit 220 is rotatable.

Therefore, when the controller 250 controls the opening and closing unit 220 to be rotated to shield the first channel 150, a flow of exhaust gas to the first channel 150 is interrupted by the opening and closing unit 220 and a flow of exhaust gas to the second channel 200 is permitted. On the other hand, when the controller 250 controls the opening and closing unit 220 to be rotated to shield the second channel 200, the flow of exhaust gas to the second channel 200 is interrupted by the opening and closing unit 220 and the flow of exhaust gas to the first channel 150 is permitted.

FIGS. 5 and 6 illustrates one form of the present disclosure in which the first channel 150 and the second channel 200 are provided as a stack structure and the opening and closing unit 220 is hinged to the stack point between the first channel 150 and the second channel 200, i.e., the inlets of the first and second channels 150 and 200, so as to be rotatable.

In one form, the single opening and closing unit 220 having a simple structure shields one channel when it opens the other channel, and may thus simultaneously determine whether or not the flows of exhaust gas to the first and second channels 150 and 200 is permissible.

Further, if the driving condition of the vehicle corresponds to the regeneration mode of the exhaust gas purification device, the controller 250 controls the opening and closing unit 220 to interrupt the flow of exhaust gas to the first channel 150 and to permit the flow of exhaust gas to the second channel 200, thereby inhibiting or preventing incomplete combustion products in exhaust gas from being deposited in the first channel 150.

In more detail, among exhaust gas purification devices for vehicles, a device which reduces the amount of foreign substances in exhaust gas by collecting foreign substances (particularly, dust or incompletely combusted carbon oxides), such as a DPF, may perform the regeneration mode in which collected foreign substances are removed so that a collector may be regenerated.

When the vehicle enters the regeneration mode of the exhaust gas purification device, a fuel is injected through excessive injection, post injection or an injector provided at an exhaust pipe and thus the amount of carbon materials in exhaust gas is increased, and an engine RPM is raised or an exhaust temperature is raised due to continuous combustion of the increased carbon materials in exhaust gas.

When the exhaust temperature is raised and the distribution amount of carbon materials in exhaust gas is increased, foreign substances collected in the collector are combusted and the exhaust gas purification device is regenerated by removing the foreign substances in the collector through combustion.

Further, in the case of an exhaust gas purification device which removes emission regulated substances using a catalyst device, in order to adjust a temperature to satisfy catalytic reaction conditions, incomplete combustion products (particularly, carbon materials) in exhaust gas may be increased.

If the driving condition of the vehicle corresponds to the regeneration mode of the exhaust gas purification device, such as the DPF, the amount of foreign substances, particularly incomplete combustion products, in exhaust gas is rapidly increased. In this case, the first unit flow paths 155 of the first channel 150 may be easily clogged with the foreign substances, as described above.

Therefore, if the driving condition of the vehicle corresponds to the regeneration mode of the exhaust gas purification device, the flow of exhaust gas to the first channel 150 is interrupted and the second channel 200 is operated, thereby inhibiting or preventing foreign substances, particularly incomplete combustion products, in exhaust gas from being adhered to the first channel 150.

Particularly, if the first and second channels 150 and 200 are provided as the exhaust gas cooling path on the EGR path 50, the second channel 200 is operated and thus the EGR system may be operated together with execution of the regeneration mode of the exhaust gas purification device, differently from the conventional case in which the EGR system is inevitably interrupted to inhibit or prevent the EGR cooling path from being clogged as the regeneration mode of the exhaust gas purification device is performed. FIG. 5 illustrates that the controller 250 controls the opening and closing unit 220 to interrupt the first channel 150 and to operate the second channel 200 so that exhaust gas flows through the second channel 200.

Accordingly, in order to regenerate the exhaust gas purification device, such as a DPF or an LNT, the amount of foreign substances in exhaust gas is increased and the second channel 200 having a relatively large cross-sectional area is operated, thereby effectively inhibiting or preventing clogging of the first channel 150 and permitting the flow of exhaust gas simultaneously with execution of the regeneration mode of the exhaust gas purification device.

Further, if the driving condition of the vehicle corresponds to the cold driving state, the controller 250 controls the opening and closing unit 220 to interrupt the flow of exhaust gas to the first channel 150 and to permit the flow of exhaust gas to the second channel 200, thereby inhibiting or preventing incomplete combustion products in exhaust gas from accumulating in the first channel 150.

In more detail, if the driving condition of the vehicle corresponds to the cold driving state, combustion conditions, such as temperature, etc., are improper and thus there is high likelihood that a fuel introduced into the engine is not completely combusted and incomplete combustion products are contained in exhaust gas.

Therefore, if the driving condition of the vehicle corresponds to the cold driving state, the controller 250 interrupts the flow of exhaust gas to the first channel 150 and operates the second channel 200 and thus inhibits or prevents foreign substance, particularly incomplete combustion products, in exhaust gas from being adhered to and clogging the first channel 150. FIG. 5 illustrates that the controller 250 controls the opening and closing unit 220 to interrupt the first channel 150 and to operate the second channel 200 so that exhaust gas flows through the second channel 200.

Whether or not the vehicle is in the cold driving state may be determined through various methods. In one form, the controller 250 may determine that the vehicle is in the cold driving state if a measured outdoor air temperature is a reference value or lower or a coolant temperature is a reference value or lower (for example, approximately 90° C. degree).

Particularly, if the first and second channels 150 and 200 are provided as the exhaust gas cooling path on the EGR path 50, the second channel 200 is operated, differently from the conventional case in which there is high likelihood of clogging the EGR cooling path as the vehicle is in the cold driving state, and, thus, the EGR system may be stably operated even in the cold driving state of the vehicle.

Accordingly, even in a situation in which the driving condition of the vehicle corresponds to the cold driving state, an atmospheric temperature is excessively low and the amount of foreign substance, such as incomplete combustion products, in exhaust gas is increased, the second channel 200 having a relatively large cross-sectional area is operated, thereby effectively inhibiting or preventing clogging of the exhaust path 10.

Further, if the driving condition of the vehicle corresponds to the rapid acceleration state, the controller 250 controls the opening and closing unit 220 to interrupt the flow of exhaust gas to the first channel 150 and to permit the flow of exhaust gas to the second channel 200, thereby reducing flow resistance of exhaust gas.

In more detail, if the driving condition of the vehicle corresponds to the rapid acceleration state, the amount of intake air desired for a combustion process in the engine is rapidly increased. The emission amount of exhaust gas is rapidly increased as much as increase in the amount of intake air and, if exhaust gas flows through the exhaust path 10 having large differential pressure, exhaust gas pumping loss to increase the emission amount of exhaust gas is increased.

Therefore, it is determined that the driving condition of the vehicle corresponds to the rapid acceleration state, the controller 250 shields the first channel 150 including the first unit flow paths 155 having a small cross-sectional area and densely disposed and opens the second channel 200 including the second unit flow paths 205 having a large cross-sectional area and facilitating a flow of exhaust gas to allow exhaust gas to flow through the second channel 200, thereby reducing exhaust gas pumping loss in the rapid acceleration state of the vehicle.

Further, even if the first and second channels 150 and 200 are provided as the exhaust gas cooling path on the EGR path 50, when the driving condition of the vehicle corresponds to the rapid acceleration state, in order to more rapidly satisfy the rapidly increased amount of intake air of the engine, operation of the second channel 200 having lower exhaust resistance than the first channel 150 and thus small differential pressure between the inlet and the outlet is advantageous in terms of engine efficiency. FIG. 5 illustrates that the controller 250 controls the opening and closing unit 220 to interrupt the first channel 150 and to operate the second channel 200 so that exhaust gas flows through the second channel 200.

The controller 250 may determine whether or not the vehicle is in the rapid acceleration state through various methods. In one form, the controller 250 may determine that the vehicle is in the rapid acceleration state if a change rate of the pressing amount of an accelerator pedal is a designated level or more.

For example, if a change rate of the pressing amount of the accelerator pedal is approximately 30% or more per unit time, the controller 250 may determine that the driving condition of the vehicle corresponds to the rapid acceleration state. The pressing amount is determined based on a ratio of a current pressing amount to the maximum pressing amount. Such a criterion may be variously modified by those skilled in the art.

When it is determined that the driving condition of the vehicle corresponds to the rapid acceleration state, the second channel 200 including the second unit flow paths 205 having a greater cross-sectional area than the first unit flow paths 155 of the first channel 150 is operated, thereby reducing flow resistance of exhaust gas and thus satisfying the temporarily increased emission amount of exhaust gas. Further, if the first and second channels 150 and 200 are provided as the EGR cooler 100, an EGR desired amount which is temporarily increased may be satisfied.

In another form, if the driving condition of the vehicle does not correspond to the regeneration mode of the exhaust gas purification device, the cold driving state and the rapid acceleration state, the controller 250 controls the opening and closing unit 220 to permit the flow of exhaust gas to the first channel 150 and to interrupt the flow of exhaust gas to the second channel 200.

In more detail, since the first unit flow paths 155 of the first channel 150 have a smaller cross-sectional area than a cross-sectional area of the second unit flow paths 205 of the second channel 200 and thus have a large contact area with exhaust gas, as described above, cooling efficiency of exhaust gas by the first channel 150 is higher than the second channel 200. Therefore, if the driving condition of the vehicle does not correspond to the specific conditions (the regeneration mode of the exhaust gas purification device, the cold driving state, the rapid acceleration state, etc.) and operation of the second channel 200 is not desired, the controller controls the opening and closing unit 220 to interrupt the flow of exhaust gas to the second channel 200 and to permit the flow of exhaust gas to the first channel 150 so that exhaust gas flows through the first channel 150.

Particularly, if the first and second channels 150 and 200 are provided as the exhaust gas cooling path on the EGR path 50, in the case that the driving condition of the vehicle does not correspond to the regeneration mode of the exhaust gas purification device, the cold driving state and the rapid acceleration state and operation of the second channel 200 is not required, the first channel 150 is operated and thus cooling efficiency of exhaust gas recirculated to the intake side 20 is improved, an EGR amount is increased, and thus efficiency of the EGR system is improved. FIG. 6 illustrates that the controller 250 controls the opening and closing unit 220 to shield the second channel 200 and to operate the first channel 150.

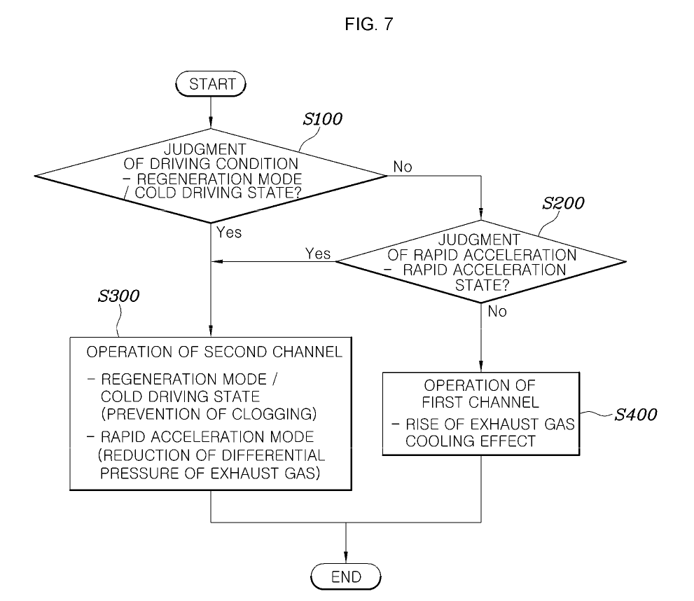

As shown in FIGS. 6 to 7, a control method of an exhaust system for vehicles in accordance with one form of the present disclosure includes: judging, by a controller 250, whether or not the driving condition of a vehicle corresponds to a regeneration mode of an exhaust gas purification device or a cold driving state (Operation S100), and controlling, by the controller 250, an opening and closing unit 220 provided between inlets of a first channel 150 and a second channel 200 to interrupt the flow of exhaust gas to the first channel 150 including a plurality of first unit flow paths 155 and to permit the flow of exhaust gas to the second channel 200 including a plurality of second unit flow paths 205 having a greater cross-sectional area than a cross-sectional area of the first unit flow paths 155 so as to inhibit or prevent incomplete combustion products in exhaust gas from being deposited in the first channel 150 (Operation S300), upon judging that the driving condition of the vehicle corresponds to one of the regeneration mode of the exhaust gas purification device and the cold driving state in judgment of the driving condition (Operation S100).

In more detail, in judgment of the driving condition (Operation S100), the controller 250 judges whether or not the driving condition of the vehicle corresponds to the regeneration mode of the exhaust gas purification device or the cold driving state. In accordance with one form of the present disclosure, the regeneration mode of the exhaust gas purification device may be judged based on the driving state of an engine, the injection state of a fuel, etc., and the cold driving state may be judged based on whether or not a coolant temperature is a designated value or lower.

Further, in operation of the second channel 200 (Operation S300), upon judging that the driving condition of the vehicle corresponds to the regeneration mode of the exhaust gas purification device or the cold driving state in Operation S100, the controller 250 controls the opening and closing unit 220 provided between the inlets of the first channel 150 and the second channel 200 to interrupt the flow of exhaust gas to the first channel 150 including the first unit flow paths 155 and to permit the flow of exhaust gas to the second channel 200 including the second unit flow paths 205 having a greater cross-sectional area than a cross-sectional area of the first unit flow paths 155 so as to inhibit or prevent incomplete combustion products in exhaust gas from being deposited in the first channel 150.

In more detail, the controller 250 controls a drive unit 225 to drive the opening and closing unit 220 so as to shield the first channel 150 and to open the second channel 200 including the second unit flow paths 205 having a greater cross-sectional area than a cross-sectional area of the first unit flow paths 155, thus inhibiting or preventing foreign substances, particularly incomplete combustion products, in exhaust gas from being adhered to or deposited in the first channel 150.

Therefore, even in the driving condition of the vehicle in which the amount of foreign substances in exhaust gas is increased, exhaust gas may flow while clogging of the exhaust path 10 due to deposition of foreign substances is inhibited or prevented. FIG. 6 illustrates the exhaust system for vehicles which is controlled so that the second channel 200 is operated by the controller 250.

As shown in FIG. 7, the control method of the exhaust system for vehicles further includes judging, by the controller 250, whether or not the driving condition of the vehicle corresponds to a rapid acceleration state (Operation S200), upon judging that the driving condition of the vehicle does not correspond to the regeneration mode of the exhaust gas purification device or the cold driving state in judgment of the driving condition (Operation S100).

Further, upon judging that the driving condition of the vehicle corresponds to the rapid acceleration state (Operation S200), the controller 250 controls the opening and closing unit 220 to interrupt the flow of exhaust gas to the first channel 150 and to permit the flow of exhaust gas to the second channel 200 (Operation S300), thereby reducing flow resistance of exhaust gas.

In more detail, upon judging that the driving condition of the vehicle does not correspond to the regeneration mode of the exhaust gas purification device or the cold driving state in which the amount of incomplete combustion products in exhaust gas is increased, the controller 250 judges whether or not the vehicle is in the rapid acceleration state in which the flow amount of exhaust gas should be rapidly changed.

In judgment of the rapid acceleration state (Operation S200), upon judging that the driving condition of the vehicle corresponds to the rapid acceleration state, the controller 250 controls the opening and closing unit 220 to shield the first channel 150 and to operate the second channel 200. Thereby, flow resistance of exhaust gas by rapid acceleration of the vehicle may be reduced and thus exhaust gas pumping loss to satisfy the rapidly increased emission amount of exhaust gas may be reduced and, particularly, if the first and second channels 150 and 200 are used as a cooling path of an EGR system, a rapidly increased EGR amount may be satisfied.

As shown in FIGS. 5 and 7, the control method of the exhaust system for vehicles further includes controlling, by the controller 250, the opening and closing unit 220 to permit the flow of exhaust gas to the first channel 150 and to interrupt the flow of exhaust gas to the second channel 200 (Operation S400), upon judging that the vehicle is not in the rapid acceleration state in judgment of the rapid acceleration state (Operation S200).

In more detail, upon judging that the driving condition of the vehicle does not correspond to specific conditions (e.g., the regeneration mode of the exhaust gas purification device, the cold driving state, or the rapid acceleration state), the controller 250 controls the opening and closing unit 220 to shield the second channel 200 and to operate the first channel 150 having a greater contact area with exhaust gas than the second channel 200 so that exhaust gas may flow through the first channel 150.

Particularly, if the first and second channels 150 and 200 are used as the cooling path of the EGR system, the first channel 150 having excellent cooling efficiency, as compared to the second channel, is operated to cool exhaust gas, thereby improving cooling efficiency of exhaust gas.

As is apparent from the above description, an exhaust system for vehicles and a control method thereof in accordance with the present disclosure may inhibit or prevent an exhaust gas cooling path from being clogged with foreign substances according to driving conditions of a vehicle and simultaneously achieve effective exhaust gas cooling efficiency.

Particularly, the exhaust system for vehicles includes a first channel having a fine unit flow area and a second channel having a greater unit flow area than the first channel and cool exhaust gas by operating a channel, which may inhibit or prevent the exhaust gas cooling path from being clogged with foreign substances according to driving conditions of the vehicle, thereby inhibiting or preventing the exhaust gas cooling path from being clogged with foreign substances.

Further, the first channel is formed by stacking heat exchanger plates provided with a plurality of heat exchanger fins so as to increase cooling efficiency of exhaust gas and the second channel is formed by a plurality of tube-type unit paths so as to inhibit or prevent the exhaust gas cooling path from being clogged with foreign substances.

An opening and closing unit to control the flow of exhaust gas to the first channel and the second channel is provided at a branch point between the first channel and the second channel so as to be rotatable and, thus, the single opening and closing unit may effectively control the flows of exhaust gas to both channels.

A controller may judge whether or not the driving condition of the vehicle corresponds to a situation in which the amount of foreign substances in exhaust gas is increased, i.e., a regeneration mode of an exhaust gas purification device, a cold driving state or a rapid acceleration state, and control the opening and closing unit to operate the second channel in the above driving condition, thereby improving cooling efficiency while effectively inhibiting or preventing the exhaust gas cooling path from being clogged with foreign substances.

Although the exemplary forms of the present disclosure have been disclosed for illustrative purposes, those skilled in the art will appreciate that various modifications, additions and substitutions are possible, without departing from the scope and spirit of the present disclosure.

What is claimed is:

1. An exhaust system for vehicles, comprising:
a first channel including a plurality of first unit flow paths formed by stacking a plurality of heat exchanger plates provided with heat exchanger fins;
a second channel provided in parallel with the first channel and including a plurality of heat exchanger tubes respectively forming a plurality of second unit flow paths having a greater cross-sectional area than a cross-sectional area of the first unit flow paths;
an opening and closing unit configured to selectively shield the first channel and the second channel; and
a controller configured to control the opening and closing unit based on driving conditions of a vehicle so as to control flows of exhaust gas to the first channel and the second channel.

2. The exhaust system for vehicles according to claim 1, wherein the first channel and the second channel are provided on an exhaust path to recirculate the exhaust gas to an intake side so as to cool the exhaust gas.

3. The exhaust system for vehicles according to claim 1, wherein the opening and closing unit is provided at a branch point of an exhaust path between inlets of the first channel and the second channel and selectively shields any one of the first channel and the second channel.

4. The exhaust system for vehicles according to claim 3, wherein the opening and closing unit is provided at the branch point so as to be rotatable, and is rotated to selectively shield any one of the first channel and the second channel.

5. The exhaust system for vehicles according to claim 1, wherein, when the driving conditions of the vehicle corresponds to a regeneration mode of an exhaust gas purification device, the controller controls the opening and closing unit to interrupt the flow of the exhaust gas to the first channel and to permit the flow of the exhaust gas to the second channel so as to inhibit incomplete combustion products in the exhaust gas from being deposited in the first channel.

6. The exhaust system for vehicles according to claim 1, wherein, when the driving conditions of the vehicle corresponds to a cold driving state, the controller controls the opening and closing unit to interrupt the flow of the exhaust gas to the first channel and to permit the flow of the exhaust gas to the second channel so as to inhibit incomplete combustion products in the exhaust gas from being deposited in the first channel.

7. The exhaust system for vehicles according to claim 1, wherein, when the driving conditions of the vehicle corresponds to a rapid acceleration state, the controller controls the opening and closing unit to interrupt the flow of the exhaust gas to the first channel and to permit the flow of the exhaust gas to the second channel so as to reduce flow resistance of the exhaust gas.

8. The exhaust system for vehicles according to claim 1, wherein, when the driving conditions of the vehicle does not correspond to a regeneration mode of an exhaust gas purification device, a cold driving mode and a rapid acceleration state, the controller controls the opening and closing unit to permit the flow of the exhaust gas to the first channel and to interrupt the flow of the exhaust gas to the second channel.

9. A control method of an exhaust system for vehicles, comprising:
judging, by a controller, whether or not a driving condition of a vehicle corresponds to a regeneration mode of an exhaust gas purification device or a cold driving state; and
controlling, by the controller, an opening and closing unit provided between inlets of a first channel and a second channel to interrupt a flow of exhaust gas to the first channel including a plurality of first unit flow paths and to permit a flow of exhaust gas to the second channel including a plurality of second unit flow paths having a greater cross-sectional area than a cross-sectional area of the first unit flow paths so as to inhibit incomplete combustion products in exhaust gas from being deposited in the first channel, upon judging that the driving condition of the vehicle corresponds to the regeneration mode of the exhaust gas purification device or the cold driving state in judgment of the driving condition.

10. The control method according to claim 9, further comprising judging, by the controller, whether or not the driving condition of the vehicle corresponds to a rapid acceleration state, upon judging that the driving condition of the vehicle does not correspond to the regeneration mode of the exhaust gas purification device or the cold driving state in judgment of the driving condition.

11. The control method according to claim 10, wherein, upon judging that the driving condition of the vehicle corresponds to the rapid acceleration state, the controller controls the opening and closing unit to interrupt the flow of exhaust gas to the first channel and to permit the flow of exhaust gas to the second channel so as to reduce flow resistance of exhaust gas in operation of the second channel.

12. The control method according to claim 10, further comprising controlling, by the controller, the opening and closing unit to permit the flow of exhaust gas to the first channel and to interrupt the flow of exhaust gas to the second channel, upon judging that the driving condition of the vehicle does not correspond to the rapid acceleration state.
